(19) United States
(12) Patent Application Publication
(10) Pub. No.: US 2024/0240029 A1
(43) Pub. Date: Jul. 18, 2024

(54) RADIATION-CURED BIO-BASED DURABLE TOPCOATS

(71) Applicant: von Holzhausen, Pacific Palisades, CA (US)

(72) Inventors: Dayong Chen, Los Angeles, CA (US); Vicki von Holzhausen, Pacific Palisades, CA (US); Craig Andrew Machado, Burbank, CA (US)

(21) Appl. No.: 18/412,405

(22) Filed: Jan. 12, 2024

Related U.S. Application Data
(60) Provisional application No. 63/479,952, filed on Jan. 13, 2023.

(51) Int. Cl. C09D 4/06; C09D 133/10; C09D 133/26; D06N 3/00

(52) U.S. Cl. CPC C09D 4/06; C09D 133/10; C09D 133/26; D06N 3/0081; D06N 3/0097; D06N 2203/041; D06N 2205/20; D06N 2207/12

(57) ABSTRACT

Radiation-curing bio-based durable topcoats or coatings and a radiation cure method of producing leather alternatives are disclosed. Biobased non-isocyanate poly(hydroxyl urethane) (NIPU), biobased polyesters, biobased polyethers, biobased polycarbonates, and biobased polyamides can be readily synthesized, and further modified with biobased acryloyl chloride, methacryloyl chloride, or itaconic anhydride into biobased radiation curable prepolymers. Through formulating such obtained biobased prepolymers with biobased acrylate and biobased methacrylate monomers, and using a radiation cure method, durable topcoats and leather alternatives with low environmental footprints can be obtained.

### 1. CROSS-REFERENCE TO RELATED APPLICATIONS

This application claims the benefit of U.S. Provisional Patent Application No. 63/479,952, filed on Jan. 13, 2023, which is incorporated by reference herein in its entirety.

### 2. BACKGROUND

Polyurethane coatings are broadly used as textile coatings, synthetic leather topcoats, animal leather top-finishes, wood coatings, floor coatings, paper coatings, architectural coatings, aerospace coatings, automotive coatings and industrial maintenance coatings, making them among the most versatile coating types available. While other types of topcoats are being developed including epoxy types or acrylic types, polyurethane topcoats are generally still preferred thanks to their intrinsic and tunable properties such as flexibility, abrasion and chemical resistance, thermal stability and good mechanical performances. Typically, 2K polyurethanes are produced by the polyaddition reaction of petroleum-based polyisocyanates with petroleum-based polyols. In the industrial production process, toxic phosgene gas is used to produce highly reactive isocyanate monomers, which is toxic to the environment and to human health. Such manufactured polyurethanes tend to have a high carbon footprint, and they are not typically degradable after usage, leading to plastic pollution.

It is desirable to synthesize isocyanate-free polyurethanes with biobased raw materials to improve the sustainability of and reduce the environmental impact of the raw materials, the manufacturing process, and the end of product life while maintaining the remarkable properties of polyurethane.

### 3. SUMMARY

In one aspect of the invention, a composition includes a combination of one or more biobased (meth)acrylamide/itaconate functional non-isocyanate polyurethane (NIPU) prepolymers, one or more biobased (meth)acrylate functional polyesters/polyethers/polycarbonates/polyamides prepolymers, and one or more biobased (meth)acrylate monomers as reactive diluents, where the materials are monomers or prepolymers and wherein the composition is in the form of a coating. In one embodiment, the coating is a topcoat for a flexible substrate construct.

In one embodiment, a biobased radiation curable formula for a flexible substrate coating comprises a combination of materials selected from: (i) one or more biobased (meth)acrylamide/itaconate functional non-isocyanate polyurethane (NIPU) prepolymers; (ii) one or more biobased (meth)acrylate functional polyesters/polyethers/polycarbonates/polyamides prepolymers; and (iii) one or more biobased (meth)acrylate monomers as reactive diluents.

In accordance with any of the embodiments, the one or more biobased (meth)acrylamide/itaconate functional NIPU prepolymers are formed by reacting one or more plant oils-based carbonates with an amount of biobased diamine monomers to produce amino functional NIPU prepolymers.

In accordance with any of the embodiments, the amino functional NIPU prepolymers have a molecular weight ranging from 1000 to 10,000.

In accordance with any of the embodiments, the one or more plant oils-based carbonates are synthesized by carbon dioxide insertion in epoxidized modified plant-based oils.

In accordance with any of the embodiments, the synthesized plant oils-based carbonates are biobased and carbon negative.

In accordance with any of the embodiments, the epoxidized modified plant-based oils comprise an oil with a degree of functionality of 2.

In accordance with any of the embodiments, the epoxidized modified plant-based oils comprise epoxidized propylene glycol dioleate.

In accordance with any of the embodiments, the biobased diamine monomers comprise diaminoisosorbide, isophoronediamine (Vestamin® eCO IPD), lysine, furanyl amines, 1,5-diaminopentane, hexamethylenediamine, or dimer fatty acid diamine (Croda Priamine® 1071).

In accordance with any of the embodiments, the one or more biobased (meth)acrylate functional polyesters/polyethers/polycarbonates/polyamides prepolymers are synthesized by modifying bio-based polyester polyols, bio-based polyether polyols, bio-based polycarbonate polyols or bio-based polyamide polyols through a one-step reaction with biobased acrylic acid or methacrylic acid.

In accordance with any of the embodiments, the bio-based polyester polyols, bio-based polyether polyols, bio-based polycarbonate polyols and bio-based polyamide polyols comprise Bio-Hoopol products from Synthesia Technology Group (11003, 11904, 12003 and 13003), CA-D020SZX and CA-D020SuZX from Gantrade, Velvetol® from WeylChem: EMEROX® Polyols from Emery Oleochemicals: Reactive polyamide polyols (Aptalon™ 9500, Aptalon™ 9501, Aptalon™ XPD 8502 and Aptalon™ XPD 8511) from Lubrizol, BENEBIOL NL2000D from Mitsubishi Chemical, Bio polyols (B-5613, B-3235 and B-3784) from Mitsui Chemicals and SKC Polyurethanes Inc (MCNS), Sovermol® from BASF, BiOH® products from Cargill, and Priplast from Croda.

In accordance with any of the embodiments, the biobased (meth)acrylate monomers as reactive diluents comprise one or a combination of biobased isobornyl acrylate (IBOA) and lauryl acrylate (LA).

In one embodiment, a method for radiation-curing a coating for a flexible substrate comprises applying one or more layers of fluids on a release paper, each layer including a radiation-curable formula for a coating; radiation-curing the one or more layers of fluids; and applying a flexible substrate backing on the one or more layers.

In accordance with any of the embodiments, each layer of fluid includes a formula comprising: (i) one or more biobased (meth)acrylamide/itaconate functional non-isocyanate polyurethane (NIPU) prepolymers; (ii) one or more biobased (meth)acrylate functional polyesters/polyethers/polycarbonates/polyamides prepolymers; and (iii) one or more biobased (meth)acrylate monomers as reactive diluents.

In accordance with any of the embodiments, applying the one or more layers of fluids comprises: applying a top surface layer on the release paper: applying a bulk body layer on the top surface layer; and radiation-curing the one or more layers of fluids comprises simultaneously radiation-curing the top surface layer and the bulk body layer.

In accordance with any of the embodiments, the method further comprise applying the top surface layer and the bulk body layer simultaneously or near simultaneously through a pre-metered slot die coating method.

In accordance with any of the embodiments, the method further comprises applying an adhesive layer on the one or more layers of fluids; and radiation-curing the adhesive layer.

In accordance with any of the embodiments, the adhesive layer comprises a black pigmented NIPU (meth)acrylamide/itaconate formula with a thermally activated initiator.

In accordance with any of the embodiments, the adhesive layer comprises an amine-terminated NIPU prepolymer with acrylated soybean oil without a thermal initiator.

In accordance with any of the embodiments, the flexible substrate is one of leather, faux leather, fabric, cloth, flexible polyurethane (PU) fabric, or a backing textile.

In accordance with any of the embodiments, a flexible substrate construct is formed by the method.

In one embodiment, a radiation-cured coating for a flexible substrate comprises polymerized material of a combination of materials selected from: (i) one or more biobased (meth)acrylamide/itaconate functional non-isocyanate polyurethane (NIPU) prepolymers; (ii) one or more biobased (meth)acrylate functional polyesters/polyethers/polycarbonates/polyamides prepolymers; and (iii) one or more biobased (meth)acrylate monomers as reactive diluents.

In accordance with any of the embodiments, the one or more biobased (meth)acrylamide/itaconate functional NIPU prepolymers are formed by reacting one or more plant oils-based carbonates with an amount of biobased diamine monomers to produce amino functional NIPU prepolymers.

In accordance with any of the embodiments, the amino functional NIPU prepolymers have a molecular weight ranging from 1000 to 10,000.

In accordance with any of the embodiments, the one or more plant oils-based carbonates are synthesized by carbon dioxide insertion in epoxidized modified plant-based oils.

In accordance with any of the embodiments, the synthesized plant oils-based carbonates are biobased and carbon negative.

In accordance with any of the embodiments, the epoxidized modified plant-based oils comprise an oil with a degree of functionality of 2.

In accordance with any of the embodiments, the epoxidized modified plant-based oils comprise epoxidized propylene glycol dioleate.

In accordance with any of the embodiments, the biobased diamine monomers comprise diaminoisosorbide, isophoronediamine (Vestamin® eCO IPD), lysine, furanyl amines, 1,5-diaminopentane, hexamethylenediamine, or dimer fatty acid diamine (Croda Priamine® 1071).

In accordance with any of the embodiments, the one or more biobased (meth)acrylate functional polyesters/polyethers/polycarbonates/polyamides prepolymers are synthesized by modifying bio-based polyester polyols, bio-based polyether polyols, bio-based polycarbonate polyols or bio-based polyamide polyols through a one-step reaction with biobased acrylic acid or methacrylic acid.

In accordance with any of the embodiments, the bio-based polyester polyols, bio-based polyether polyols, bio-based polycarbonate polyols and bio-based polyamide polyols comprise Bio-Hoopol products from Synthesia Technology Group (11003, 11904, 12003 and 13003), CA-D020SZX and CA-D020SuZX from Gantrade, Velvetol® from WeylChem; EMEROX® Polyols from Emery Oleochemicals; Reactive polyamide polyols (Aptalon™ 9500, Aptalon™ 9501, Aptalon™ XPD 8502 and Aptalon™ XPD 8511) from Lubrizol, BENEBIOL NL2000D from Mitsubishi Chemical, Bio polyols (B-5613, B-3235 and B-3784) from Mitsui Chemicals and SKC Polyurethanes Inc (MCNS), Sovermol® from BASF, BiOH® products from Cargill, and Priplast from Croda.

In accordance with any of the embodiments, the biobased (meth)acrylate monomers as reactive diluents comprise one or a combination of biobased isobornyl acrylate (IBOA) and lauryl acrylate (LA).

### 4. BRIEF DESCRIPTION OF THE SEVERAL VIEWS OF THE DRAWINGS

The patent or application file contains at least one drawing executed in color. Copies of this patent or patent application publication with color drawing(s) will be provided by the Office upon request and payment of the necessary fee.

These and other features, aspects, and advantages of the present invention will become better understood with regard to the following description, and accompanying drawings, where:

FIG. 1 illustrates a schematic of a radiation-based (e-beam) curing process of flexible substrate construct production, according to an embodiment.

FIG. 2A illustrates a cross-sectional diagram of the top surface layer and the bulk body layer of the coating, in accordance with an embodiment.

FIG. 2B illustrates a cross-sectional diagram of the product including a back fabric, an adhesive, a bulk body layer, and a top surface layer, in accordance with an embodiment.

### 5. DETAILED DESCRIPTION

### 5.1. Definitions

The term “bio-based” or “biobased” is used throughout to refer to materials or chemicals that are derived from renewable biomass or bio-fermented products instead of petroleum.

The term “degree of functionality” refers to the number of functional groups or bonding sites in a monomer or molecule for bonding.

### 5.2. Coatings

Described here is a synthesis procedure of biobased (meth)acrylamide/itaconate functional NIPU prepolymers, and formulation schemes of radiation cured bio-based durable topcoats by combining biobased (meth)acrylamide/itaconate functional NIPU prepolymers with biobased (meth)acrylate functional polyesters/polyethers/polycarbonates/polyamides prepolymers, and biobased (meth)acrylate monomers as reactive diluents. Further, a radiation-cure method of producing flexible substrate constructs using such formulated radiation-cured bio-based topcoat formulas is disclosed.

One aspect of the present disclosure is the provision of a composition comprising one or more biobased (meth)acrylamide/itaconate functional NIPU prepolymers, one or more biobased (meth)acrylate functional polyesters/polyethers/polycarbonates/polyamides/poly(hydroxyurethanes) prepolymers, and one or more biobased (meth)acrylate monomers, which may be reactive diluents. In one embodiment, the composition is a coating or topcoat. In a further embodiment, the coating or topcoat is designed to be durable.

Out of several reported synthesis pathways of isocyanate-free polyurethanes, biobased non-isocyanate poly(hydroxyl urethane) (NIPU) with the use of cyclic carbonate (CC) monomers cross-linked by primary amino groups of aliphatic or cycloaliphatic polyamines provides a desirable and low-cost approach. However, the curing speed and efficiency of NIPUs is typically comparably lower than the traditional 2K polyurethanes.

In many areas of the coatings industry, radiation-cured coatings have benefits in reduced energy consumption and waste generation, minimal or reduced VOCs and environmental impact, smaller carbon footprint, and faster cure times compared to traditional methods. Radiation-cured coatings cross-link by reactions initiated by radiation, rather than heat. Such coatings have the potential advantage of being indefinitely stable when stored in the absence of radiation.

In one embodiment, cross-linking occurs rapidly at ambient temperature on exposure to radiation. Biobased non-isocyanate poly(hydroxyl urethane) (NIPU) prepolymers can be modified into (meth)acrylamide/itaconate functional NIPU prepolymers. Combining these NIPU prepolymers with reactive diluents. 100% solid radiation-curable coatings can be formulated, applied, and efficiently cured by either ultraviolet (UV) or electron-beam (e-beam) exposure.

The speed and energy efficiency of radiation curing dwarfs those of the traditional 2K polyurethanes. Moreover, radiation-cured NIPUs can offer pathways of achieving 100% biobased and carbon negative formulas. However, radiation-cured biobased NIPU topcoats with supple and durable mechanical properties mimicking the haptics and mechanical properties of animal skin leathers provide an advantage over conventional designs.

In one instance, synthetic leathers or leather alternatives made of solvent-borne 2-component polyurethane (PU) and water-borne polyurethane dispersions are manufactured through a multiple-step coating and oven-curing/drying process. In a dry method of producing a PU leather, a mixed PU material as the top surface finish is applied on the release paper followed by an oven curing/drying step. Then, another mixed PU material as the middle body layer is applied on top of the first layer, followed by another oven curing/drying step. Then, a third mixed PU material as the adhesive layer is applied on the body layer, and the backing fabric is laminated before a third oven curing/drying process.

Finally, the release paper is split from the constructed PU leather, and both the release paper and the PU leather are wound into rolls. To ensure rapid production and complete curing, the three continuous production ovens are large in size and maintained at 120-160° C., which results in an energy intensive process. Given all the benefits of lower energy consumption, reduced waste generation, minimal VOCs and environmental impact, smaller carbon footprint, and faster cure times, a radiation method of producing synthetic leathers or leather alternatives provides an advantage over conventional designs.

As stated above, in certain embodiments, the composition is in the form of a topcoat. In one embodiment, the topcoat described herein is a coating that is applied to a flexible substrate, including woven/knitted/non-woven fabric, cloth, paper sheet, plastic film, metal foil/mesh, animal hide leather, wood veneer, mushroom-based textile, or other types of backing textiles to protect the textile from abrasion and wear. For example, the topcoat or coating may be used with leather alternative products, such as a handbag, purse, tote, backpack, or other bag or carrying item made of a leather alternative. In one embodiment, the topcoat gives the material a waterproof protective layer and is a clear coating.

In one embodiment, the topcoat described herein may have a thickness of 25-450 μm. In some embodiments, the topcoat described herein has a thickness greater than 300 μm, a thickness greater than 320 μm, a thickness greater than 340 μm, a thickness greater than 360 μm, a thickness greater than 380 μm, a thickness greater than 400 μm.

In alternative embodiments, while the plant-based coatings are primarily engineered as topcoats for flexible substrates including leather alternatives, they are readily reformulated for other topcoat applications such as automotive exterior coatings, furniture coatings, aerospace coatings, roof coatings, and architectural coatings by masters of the art.

### 5.3. Prepolymer Materials

In an aspect of the present disclosure, one or more of the materials used to produce the provided coatings are derived from renewable resources such as biomass. In some embodiments, the materials are derived from plants (i.e., are based on materials obtained from renewable sources). For example, the materials may be derived from wood and wood processing wastes, agricultural crops and waste materials, biogenic materials, and the like.

### 5.3.1. Synthesis of biobased (meth)acrylamide/itaconate functional NIPU prepolymers

Biobased non-isocyanate poly(hydroxyl urethane) (NIPU) prepolymers are synthesized by using plant oil based cyclic carbonate (CC) monomers reacted with primary amino groups of aliphatic or cycloaliphatic polyamines. Plant-based oils are a mixture of triglycerides. Depending on the type of the plant-based oil, they have different ratios among these three different glycerides: saturated, monounsaturated, and polyunsaturated. The unsaturated C═C double bonds can be oxidized into epoxides, and insertion of carbon dioxide into the formed epoxy rings yields cyclic carbonate (CC) monomers. Such produced NIPU prepolymers can not only be biobased but also be carbon negative.
Formula 1 illustrates a general formula for a difunctional amine-terminated NIPU prepolymer. In one embodiment, R1 can be selected from the materials described in section 5.3.1. In one embodiment, R1 is obtained from fatty acids from plant-based oils, propylene glycol dioleate, and the like. In one embodiment, R2 is obtained from diaminoisosorbide, isophoronediamine, lysine, furanyl amine, 1,5-diaminopentane, hexamethylenediamine, dimer fatty acid diamine.
Formula 1. A general formula for a difunctional amine-terminated NIPU prepolymer.

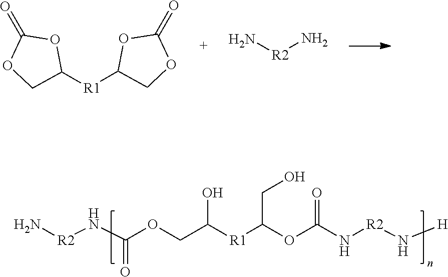

To prepare NIPU linear prepolymers, a difunctional carbonate monomer is made from modified plant oils. Epoxidized plant-based oils tend to have an average degree of epoxy functionality of 4-6. In one embodiment, these plant-based oils may not be used directly, but modified plant-based oil with a degree of functionality of 2 may be used instead. One example of a modified plant-based oil is epoxidized propylene glycol dioleate (commercially available Cargill Vikoflex® 5075).

TABLE 1
Physical properties of Vikoflex ® 5075.
TYPICAL PHYSICAL PROPERTIES

| | |
|---|---|
| [symbol] Oxygen | 4.4% Min |
| Acid Value | 1.0 Max |
| Viscosity [symbol] @ 25° C. | 1.2 |
| Color [symbol] APHA | 175 Max |
| Flash Point | <500° F. |
| Freeze Point | 32° F. |

[symbol]

indicates data missing or illegible when filed

In another embodiment, other plant-based epoxy monomers may be used. Some examples include, but are not limited to, Epotec® RD 135 G, Denacol™ GEX-313, Denacol™ GEX-521, and Denacol™ GEX-622. By using epoxides other than those based on vegetable oils, greater control over branching, chain flexibility, and density of urethane groups can be controlled.

To convert epoxidized propylene glycol dioleate (or other epoxide monomers) into a cyclic carbonate monomer through carbon dioxide insertion, a stirred pressure reactor (PAR-4530) from Parr instrument may be used. In one synthesis example, the method includes charging 1000 grams Vikoflex® 5075 epoxidized propylene glycol dioleate and 20 grams tetrabutylammonium bromide as the catalyst in the reactor.

The reactor is then charged with pressured carbon dioxide. The reactor is heated to 140° C. and the pressure maintained at 3 MPa. The reaction is then allowed to proceed for 10 hours before cooling down, yielding biobased carbonate (5075 carbonate) with nearly 100% conversion.

It is desirable to removal tetrabutylammonium bromide catalyst from the products before proceeding to coating formulation. A simple wash of the products with warm water and using a separation funnel to separate the oil phase and the water phase was found to remove approximately 95% of the catalyst. Such removed catalyst can easily be recycled for future use.

The other important monomer in developing biobased non-isocyanate poly(hydroxyl urethane) (NIPU) linear prepolymers is a biobased diamine. In one embodiment, biobased diamines can come from three different routes: 1) chemically modifying natural occurring molecules: 2) chemical synthesis based on a mass balance approach; and 3) using a bio-fermentation process. From these routes, commercially available biobased amine monomers include diaminoisosorbide, isophoronediamine (Vestamin® eCO IPD), lysine, furanyl amines, 1,5-diaminopentane, hexamethylenediamine, and dimer fatty acid diamine (Croda Priamine® 1071).

In a synthesis procedure, biobased non-isocyanate poly(hydroxyl urethane) (NIPU) linear prepolymers is produced by charging 5075 carbonate, biobased diamine, and 1 wt % triazabicyclodecane as a catalyst in a stirred reactor. The mixture is heated to 120° C. and maintained for at least 3 hours to allow the polymerization to complete. By using an excess of diamine, amine-terminated NIPU linear prepolymers can be synthesized. Different ratios of diamine and 5075 carbonate can be used to control the molecular weight of the NIPU prepolymers. In one embodiment, a series of NIPU prepolymers may be synthesized with the molecular weight ranging from 1000 to 10,000.

TABLE 2
Synthesis of NIPU prepolymer 1

| | Equivalent | Loading ratio |
|---|---|---|
| Tradename/Name | weight | by amount |
| Hexmethylenediamine | 58 | 5 |
| 5075 carbonate | 384 | 4 |
| triazabicyclodecane catalyst | — | 1 wt % |

TABLE 3
Synthesis of NIPU prepolymer 2

| | Equivalent | Loading ratio |
|---|---|---|
| Tradename/Name | weight | by amount |
| Hexmethylenediamine | 58 | 4 |
| 5075 carbonate | 384 | 3 |
| triazabicyclodecane catalyst | — | 1 wt % |

TABLE 4
Synthesis of NIPU prepolymer 3

| | Equivalent | Loading ratio |
|---|---|---|
| Tradname/Name | weight | by amount |
| Croda Priamine 1071 | 274 | 4 |
| 5075 carbonate | 384 | 3 |
| triazabicyclodecane catalyst | — | 1 wt % |

In one embodiment, the biobased amino terminated NIPU linear prepolymers can be modified into (meth)acrylamide functional NIPU prepolymers through reacting with biobased acryloyl chloride or methacryloyl chloride with or without a catalyst. Biobased acryloyl chloride or methacryloyl chloride can be obtained through: 1) chemically modifying naturally-occurring molecules: 2) chemical synthesis based on a mass balance approach: 3) using a bio-fermentation or enzymology process.

In a synthesis example, amine-terminated NIPU linear prepolymers and 1 wt % triethylamine as a catalyst are charged into a three-neck flask equipped with a temperature controller, a condenser, and a nitrogen inlet. The flask is purged with nitrogen, then biobased (meth)acryloyl chloride (in an amount ratio of 1.05:1 to amine) is added drop-wise while the flask is kept in a water bath to control the temperature rise due to the highly exothermic reaction.

After the complete addition, the temperature is raised to 60° C. The reaction is maintained at 60° C. for 6 hours to ensure completion. Then, the salts are filtered, the product is washed with water, and the polymer is dried to afford difunctional NIPU (meth)acrylamide prepolymer.

In another embodiment, itaconic anhydride may be used in place of (meth)acryloyl chloride. In a synthesis example, the amine-terminated NIPU linear prepolymer is charged into a three-neck flask equipped with a temperature controller, a condenser, and a nitrogen inlet. The flask is purged with nitrogen, then itaconic anhydride (in an amount ratio of 1.05:1 to amine) is added while the reaction is stirred at room temperature for 2 hours. Then, the reaction is stirred at 50° C. for 2 hours to ensure complete reaction.

### 5.3.2. Synthesis of Biobased (meth)acrylate polyesters/polyethers/polycarbonates/polyamides prepolymers

Many types of bio-based polyester polyols, bio-based polyether polyols, bio-based polycarbonate polyols and bio-based polyamide polyols are commercially available or can be readily synthesized. In one embodiment, these materials are converted into biobased (meth)acrylate prepolymers through a one-step reaction with biobased acrylol chloride or methacryloyl chloride.

While there are many options for plant-based polyols with varied plant-based carbon contents, polyols with 80-100% plant-based carbon content are chosen, and polyols with 100% plant-based carbon are preferred. The polyols include, but are not limited to, the following examples: Bio-Hoopol products from Synthesia Technology Group (11003, 11904, 12003 and 13003); CA-D020SZX and CA-D020SuZX from Gantrade; Velvetol® from WeylChem; EMEROX® Polyols from Emery Oleochemicals; Reactive polyamide polyols (Aptalon™ 9500, Aptalon™ 9501, Aptalon™ XPD 8502 and Aptalon™ XPD 8511) from Lubrizol, BENEBIOL NL2000D from Mitsubishi Chemical, Bio polyols (B-5613, B-3235 and B-3784) from Mitsui Chemicals and SKC Polyurethanes Inc. (MCNS), Sovermol® from BASF, BiOH® products from Cargill, and Priplast from Croda.

TABLE 5
Polyols from Velvetol ® family.

| Properties | Units | H250 | H200 | H1000 | H2000 | H2700 |
|---|---|---|---|---|---|---|
| [symbol] | % | 100 | 100 | 100 | 100 | 100 |
| [symbol] | Dolton | 200-300 | 4 [symbol] 0-600 | [symbol] -1100 | [symbol] -2100 | 26 [symbol] 0- [symbol] |
| [symbol] | [symbol] | 270- [symbol] | 280-187 | 125-1 [symbol] 2 | 59.3- [symbol] .4 | 4 [symbol] .3-40. [symbol] |
| [symbol] | [symbol] /20 kg | −2.0-+2.0 | −2.0-+2.0 | −2.0-+2.0 | −2.0-+2.0 | −2.0-+2.0 |
| | ppm | < [symbol] | < [symbol] | < [symbol] | < [symbol] | < [symbol] |
| [symbol] | mg [symbol] /g | <0.05 | <0.05 | <0.05 | <0.05 | |
| [symbol] | ppm | <10 | <10 | <10 | <10 | <10 |
| [symbol] | ppm | <10 | <10 | <10 | <10 | <10 |
| [symbol] | ppm | < [symbol] | < [symbol] | < [symbol] | < [symbol] | < [symbol] |
| [symbol] | max. [symbol] | max. [symbol] | max. [symbol] | max. [symbol] | max. [symbol] | max. 120 |
| [symbol] | [symbol] | 40-50 | 90-120 | 200- [symbol] 00 | 750- [symbol] | [symbol] - [symbol] |
| [symbol] | g/ml | 1.0 [symbol] | 1.020 | 1. [symbol] 18 | 1.016 | 1.016 |
| [symbol] | ° C. | <0 | 0-5 | 12-14 | 16-18 | 22-25 |

[symbol]

indicates data missing or illegible when filed

TABLE 6
Polyols from BIO-HOOPOL family.

| BIO- | BIO content* | [symbol] | AV | Mol. Weight | Malting Point | Glass Trans. [symbol] | Viscosity | |
|---|---|---|---|---|---|---|---|---|
| HOOPOL | (%) | (mg KOH/g) | (mg KOH/g) | (g/mol) | (° C.) | (° C.) | (mPa s) | |
| 9110 | >90 | 54-58 | ≤0.4 | 2000 | 33 | — | 2,500 | (40° C.) |
| 9710 | 60-70 | 56-64 | ≤1.5 | 2 [symbol] 00 | — | − [symbol] | 25000 | (2 [symbol] ° C.) |
| 11003 | 100 | 54-58 | ≤2.0 | 2000 | 4 [symbol] | — | 2,700-3,700 | (60° C.) |
| 11023 | 100 | 117-123 | ≤0.6 | 1000 | [symbol] | — | 700 | (60° C.) |
| 11034 | 60-70 | 27-34 | ≤2.0 | 3750 | — | −17 | 1,000-5,000 | (120° C.) |
| 11043 | 100 | 75-85 | ≤0.6 | 1400 | 50 | — | 1,400 | (60° C.) |
| 110 [symbol] | 100 | 165-175 | ≤0.6 | 660 | 42 | — | 380 | (60° C.) |
| 11501 | 100 | 54-58 | ≤0.5 | 2000 | 112 | — | 250 | (130° C.) |
| 115 [symbol] 3 | 100 | 54-58 | ≤2.0 | 2000 | [symbol] 7 | — | 650-141, [symbol] | ( [symbol] 0° C.) |
| 11520 | 100 | 103-117 | ≤2.0 | 1000 | 108 | — | −50 | (130° C.) |
| 11531 | 40-50 | 25-32 | ≤2.0 | 4000 | 113 | — | 400-1,600 | (130° C.) |
| 11532 | 100 | 25-32 | ≤2.0 | 4000 | 113 | — | 400-1,600 | (130° C.) |
| 11533 | 100 | 26-32 | ≤2.0 | 3900 | 96 | — | 600 | (130° C.) |
| 11580 | 100 | 37-40 | ≤0. [symbol] | 2900 | 107 | — | [symbol] 00 | (130° C.) |
| 11900 | >30 | 53-58 | ≤0. [symbol] | 2000 | 48 | — | 1,500 | (60° C.) |
| 11903 | 70-80 | 54-58 | ≤1.0 | 2000 | — | −47 | 2100 | (60° C.) |
| 11904 | 100 | 54-58 | ≤2.0 | 2000 | 23 | — | 1500 | (60° C.) |
| 11929 | >30 | 117-123 | ≤0.6 | 9 [symbol] 0 | 46 | — | 320 | (60° C.) |
| 12003 | 100 | 54-58 | ≤1.0 | 2000 | [symbol] 2 | — | 1100 | (60° C.) |
| 12530 | 100 | 27-34 | ≤2.0 | 3750 | [symbol] 2 | — | 3,000 | (80° C.) |
| 12600 | 30-40 | 50-58 | ≤2.0 | 2000 | — | −21 | 6,500 | (80° C.) |
| 12900 | > [symbol] 0 | [symbol] -89 | ≤2.0 | 2000 | [symbol] | — | 500 | (80° C.) |
| 12930 | 64 | 27-34 | ≤2.0 | 3750 | 67 | — | 1,000-4,000 | (80° C.) |
| 12970 | > [symbol] 0 | 43-47 | ≤2.0 | 2000 | 70 | — | 1,000 | (80° C.) |
| 13003 | 100 | 54-58 | ≤1.0 | 2000 | — | −51 | 1, [symbol] 00 | (60° C.) |
| 13033 | 100 | 54-58 | ≤1.0 | 3750 | — | −47 | 5,000 | (80° C.) |

[symbol]

indicates data missing or illegible when filed

TABLE 7
Polyols from EMEROX ® family.

| | [symbol] | [symbol] | [symbol] | [symbol] | [symbol] | [symbol] |
|---|---|---|---|---|---|---|
| [symbol] | [symbol] | [symbol] | [symbol] | [symbol] | [symbol] | [symbol] |
| | [symbol] | [symbol] | [symbol] | [symbol] | [symbol] | [symbol] |
| | [symbol] | [symbol] | [symbol] | [symbol] | [symbol] | [symbol] |
| [symbol] | [symbol] | [symbol] | [symbol] | [symbol] | [symbol] | [symbol] |
| | [symbol] | [symbol] | [symbol] | [symbol] | [symbol] | [symbol] |
| | [symbol] | [symbol] | [symbol] | [symbol] | [symbol] | [symbol] |
| | [symbol] | [symbol] | [symbol] | [symbol] | [symbol] | [symbol] |
| | [symbol] | [symbol] | [symbol] | [symbol] | [symbol] | [symbol] |
| [symbol] | [symbol] | [symbol] | [symbol] | [symbol] | [symbol] | [symbol] |
| | [symbol] | [symbol] | [symbol] | [symbol] | [symbol] | [symbol] |
| | [symbol] | [symbol] | [symbol] | [symbol] | [symbol] | [symbol] |
| | [symbol] | [symbol] | [symbol] | [symbol] | [symbol] | [symbol] |
| | [symbol] | [symbol] | [symbol] | [symbol] | [symbol] | [symbol] |
| | [symbol] | [symbol] | [symbol] | [symbol] | [symbol] | [symbol] |
| [symbol] | [symbol] | [symbol] | [symbol] | [symbol] | [symbol] | [symbol] |
| | [symbol] | [symbol] | [symbol] | [symbol] | [symbol] | [symbol] |
| | [symbol] | [symbol] | [symbol] | [symbol] | [symbol] | [symbol] |
| | [symbol] | [symbol] | [symbol] | [symbol] | [symbol] | [symbol] |
| | [symbol] | [symbol] | [symbol] | [symbol] | [symbol] | [symbol] |
| | [symbol] | [symbol] | [symbol] | [symbol] | [symbol] | [symbol] |

[symbol]

indicates data missing or illegible when filed

TABLE 8
Polyols from AptalonTM family.

| [symbol] | [symbol] | [symbol] | [symbol] | [symbol] | [symbol] | [symbol] | [symbol] | [symbol] | [symbol] |
|---|---|---|---|---|---|---|---|---|---|
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] |

[symbol]

[symbol]

indicates data missing or illegible when filed

TABLE 9
Polyols from BENEBIOL ™ family.

| | [symbol] | | | | [symbol] | | | | | [symbol] | | | |
|---|---|---|---|---|---|---|---|---|---|---|---|---|---|
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |

[symbol]

[symbol]

[symbol]

[symbol]

indicates data missing or illegible when filed

In a synthesis example, Bio-Hoopol 13003 and 1 wt % triethylamine as a catalyst are charged into a three-neck flask equipped with a temperature controller, a condenser, and a nitrogen inlet. Then, biobased acryloyl chloride (in an amount ratio of 1.05:1 to amine) is added drop-wise while the flask is kept in a water bath to control the temperature rise due to the highly exothermic reaction.

After the complete addition, the temperature is raised to 60° C. The reaction is maintained at 60° C. for 6 hours for completion. Then, the salts are filtered, the product is washed with water, and the polymer is dried to afford 13003 diacrylate prepolymer.

### 5.4. Formulation of Radiation Cured Bio-Based Durable Topcoats

To formulate biobased durable topcoats, biobased (meth)acrylamide/itaconate functional NIPU prepolymers were mixed with biobased (meth)acrylate functional polyesters/polyethers/polycarbonates/polyamides prepolymers, and biobased (meth)acrylate monomers as reactive diluents.

In one embodiment, biobased isobornyl acrylate (IBOA) and/or lauryl acrylate (LA) are chosen as the reactive diluent monomers for controlling the elongation to break strain, the glass transition temperature, and the curing shrinking ratio. A couple of radiation cured formula examples are presented below.

In one embodiment, radiation curing methods include UV and e-beam curing technologies. For clear coats or topcoats with small film thickness and/or low-pigment loading, ultraviolet curing can be preferred. In these cases, in one instance, Norish type I photoinitiators are incorporated in the formulas. If electron beam curing method is used, photoinitiators may not be required.

### 5.5. Radiation Cure Method of Producing Flexible Substrate Constructs

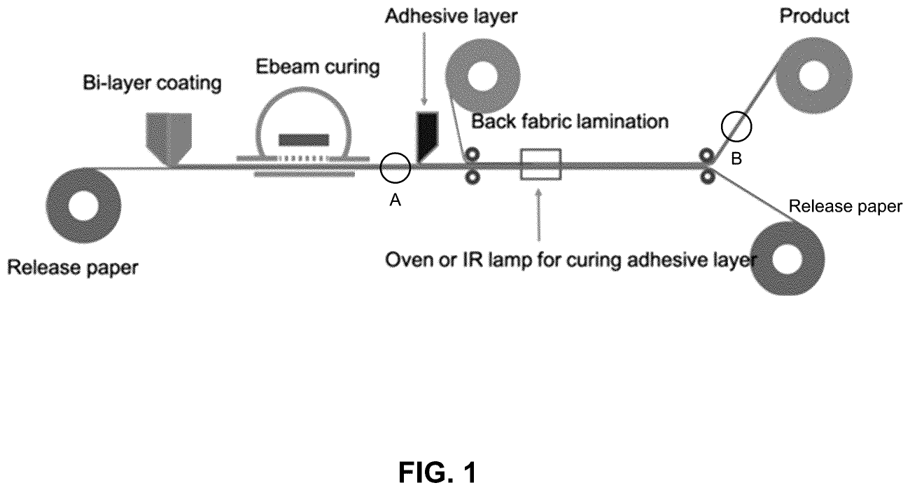

FIG. 1 illustrates a schematic of a radiation-based (e-beam) curing process of flexible substrate construct production, according to an embodiment.

In one embodiment, a PU leather alternative is constructed by a thin top surface layer, a bulk body layer, an adhesive layer on top of a fabric backing layer. The thin top surface layer is to imbue leather alternatives with haptic properties, abrasion resistance, color rubbing fastness, and weathering stability. The bulk body layer is designed to be flexible and have a large elongation to break strain, so leather alternatives have good bally flex or low temperature flexing properties. The adhesive layer is to ensure good adhesion and peeling strength between the topcoat and the backing fabric.

In the conventional manufacturing process of PU leather, a mixed PU material as the top surface layer is applied on the release paper followed by a first oven curing/drying step. Then another mixed PU material as the middle body layer is applied on the release paper again, followed by another oven curing/drying step. Then a third mixed PU material as the adhesive layer is applied on the release paper, and the backing fabric is laminated before a third oven curing/drying process. Finally, the release paper is split from the constructed PU leather, which is wound in a roll, while the release paper is rewound in a separate roll.

To produce radiation cured leather alternatives, electron beam (e-beam) curing technologies are favored over UV curing technologies because of the relatively large penetration and curing depth of electron beams, for even highly pigmented coatings. Photoinitiators are also unnecessary in e-beam formulations.

In one embodiment, an e-beam curing process of producing a flexible substrate construct is disclosed. The method includes the following steps: 1) unwinding of a textured release paper, 2) two-layer fluids composed of a top surface layer and a bulk body layer applied simultaneously on the release paper, 3) e-beam curing of the two-layers simultaneously, 4) application of an uncured adhesive layer, 5) laminating a backing fabric, 6) oven or IR cure of the adhesive layer, 8) splitting of the release paper from the leather alternative, 9) rewinding of the release paper and winding of the produced leather alternative.

In some embodiments, the energy of each electron of the electron beam is from about 100 KeV to about 350 KeV, e.g., from about 100 KeV to about 200 KeV, or from about 200 KeV to about 350 KeV. In certain embodiments, 300-350 KeV is preferred to achieve good radiation penetration and thereby good through-cure for topcoat in the thickness range of 300-400 microns.

Instead of coating the top surface layer and the bulk body layer separately on a textured release paper and curing them separately, there is a pre-metered slot die coating method to simultaneously apply these two layers of fluid on a textured release paper. Each fluid may have a separate fluid delivery system for pre-metered control. With proper slot sizing and a pump for each fluid, two-layer fluids with well-defined wet film thickness can be applied.

Considering the relatively high fluid viscosity of coating fluids (1,000-15,000 cP), small application thickness (25-300 μm), relatively slow coating speed (1-3 m/s), and low density of fluids (1.1-1.3 g/cm2). The Reynolds number is very small (<1), and the flow is in the laminar flow region far below the laminar-turbulence transition. The fast curing speed of radiation-induced free radical polymerization reduces the potential downstream mixing between layers due to diffusion. Therefore, the manufacturing process can be simplified by using one e-beam curing machine.

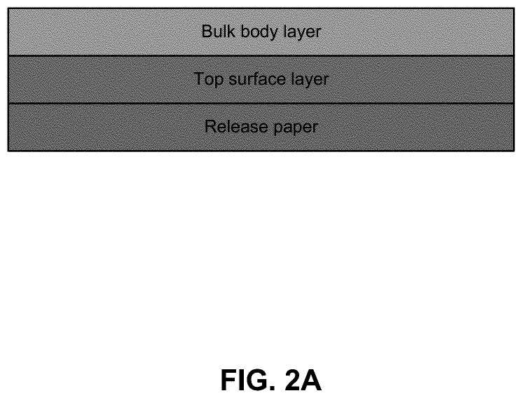

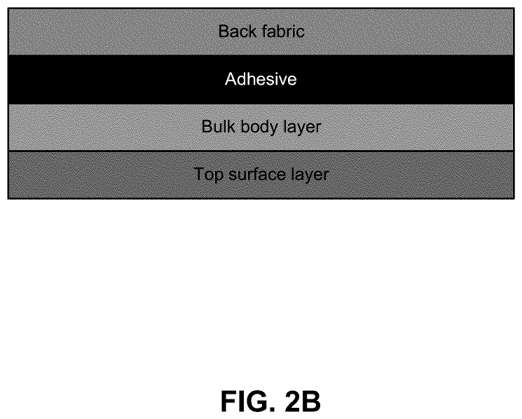

Both the top surface layer and the bulk body layer will use a previously described radiation cured biobased topcoat formula, and further examples are described in section 6 below. In one instance, the formulas can be cured without any photo initiators. An example diagram of the simultaneously cured top surface layer and the bulk body layer is shown in FIG. 2A.

After the e-beam curing step, a thin adhesive layer is coated. To make a quickly curable adhesive layer, a black pigmented NIPU (meth)acrylamide/itaconate formula with a thermally activated initiator is applied and followed by laminating a backing fabric (flexible substrate).

In a separate embodiment, the adhesive layer may be cured by curing an amine-terminated NIPU prepolymer with acrylated soybean oil. In this embodiment, the amine groups react with the acrylate groups in an aza-Michael addition mechanism, and no thermal initiator is needed.

Then, either a continuous production oven or an IR lamp is used to quickly raise the adhesive layer to above the thermal decomposition temperature of the initiator (>70° C.) or to moderate (˜50° C.) temperatures for aza-Michael addition curing. This allows a quick cure of the adhesive layer and ensures that good adhesion between the backing fabric and the topcoat is achieved. Finally, the release paper is split from the constructed PU leather. An example of the product after splitting the release paper is shown in FIG. 2B.

In certain embodiments, the multi-layered topcoats comprise pigmented and non-pigment layers. For example, the bulk body layer may include pigments for coloring and aesthetic reasons. The top surface layer may not include any pigment so that abrasion on the surface does not lead to color transfer. The adhesive layer can include IR absorbing pigments/fillers so that the adhesive layer can be quickly heat up and achieve a rapid cure.

### 6. EXAMPLES

### 6.1. Summary of the Examples

Example leather-like topcoats are formulated with as high as 96-100% plant-based carbon in the formula by using radiation cured (meth)acrylamide/itaconate NIPU prepolymers, (meth)acrylate polyesters/polyethers/polycarbonates/polyamides prepolymers, and/or biobased (meth)acrylate monomers as reactive diluents.

### 6.2. Example Topcoat Formulations

While the topcoats include pigments, dyes, and other additives, the resin systems generally determine the mechanical and physical properties of such cured topcoats. Example radiation cured topcoat resin formulas are given below.

In one embodiment, any one or a combination of these example formulations may be used as the top surface layer and the bulk body layer of a bi-layer coating, as described in conjunction with FIG. 1 and section 5.5 above.

The mixing amount ratio refers to molar mixing ratio, unless specified otherwise.

6.2.1. Formulation 1

| | | Mixing |
|---|---|---|
| | | amount |
| Tradename/Name | Element | ratio |
| NIPU diacrylamide | NIPU prepolymer | 0.7 |
| prepolymer 1 | | |
| Isobornyl acrylate | Reactive diluent | 0.3 |
| (IBOA) | monomer | |
| XPB772 | Plant-based | 2% |
| | carbon black | (by weight) |

where NIPU diacrylamide prepolymer 1 is based on NIPU prepolymer 1 but is modified with (meth)acrylamide groups.

In one embodiment, the mixing ratio of NIPU diacrylamide prepolymer 1 to IBOA may be within the range of 0.3-0.8:0.2-0.7.

6.2.2. Formulation 2

| | | Mixing |
|---|---|---|
| | | amount |
| Tradename/Name | Element | ratio |
| NIPU diacrylamide | NIPU prepolymer | 0.7 |
| prepolymer 2 | | |
| Isobornyl acrylate | Reactive diluent | 0.3 |
| (IBOA) | monomer | |
| XPB772 | Plant-based | 2% |
| | carbon black | (by weight) |

where NIPU diacrylamide prepolymer 2 is based on NIPU prepolymer 2 but is modified with (meth)acrylamide groups.

In one embodiment, the mixing ratio of NIPU diacrylamide prepolymer 2 to IBOA may be within the range of 0.3-0.8:0.2-0.7.

6.2.3. Formulation 3

| | | Mixing |
|---|---|---|
| | | amount |
| Tradename/Name | Element | ratio |
| NIPU diacrylamide | NIPU prepolymer | 0.7 |
| prepolymer 3 | | |
| Isobornyl acrylate | Reactive diluent | 0.3 |
| (IBOA) | monomer | |
| XPB772 | Plant-based | 2% |
| | carbon black | (by weight) |

where NIPU diacrylamide prepolymer 3 is based on NIPU prepolymer 3 but is modified with (meth)acrylamide groups.

In one embodiment, the mixing ratio of NIPU diacrylamide prepolymer 3 to IBOA may be within the range of 0.3-0.8:0.2-0.7.

6.2.4. Formulation 4

| | | Mixing |
|---|---|---|
| | | amount |
| Tradename/Name | Element | ratio |
| NIPU diitaconate | NIPU prepolymer | 0.7 |
| prepolymer 1 | | |
| Isobornyl acrylate | Reactive diluent | 0.3 |
| (IBOA) | monomer | |
| XPB772 | Plant-based | 2% |
| | carbon black | (by weight) |

where NIPU diitaconate prepolymer 1 is based on NIPU prepolymer 1 but is modified with itaconate groups.

In one embodiment, the mixing ratio of NIPU diitaconate prepolymer 1 to IBOA may be within the range of 0.3-0.8:0.2-0.7.

6.2.5. Formulation 5

| | | Mixing |
|---|---|---|
| | | amount |
| Tradename/Name | Element | ratio |
| NIPU diacrylamide | NIPU prepolymer | 0.7 |
| prepolymer 1 | | |
| Lauryl acrylate | Reactive diluent | 0.3 |
| (LA) | monomer | |
| XPB772 | Plant-based | 2% |
| | carbon black | (by weight) |

In one embodiment, the mixing ratio of NIPU diacrylamide prepolymer 1 to LA may be within the range of 0.3-0.8:0.2-0.7.

6.2.6. Formulation 6

| | | Mixing |
|---|---|---|
| | | amount |
| Tradename/Name | Element | ratio |
| NIPU diacrylamide | NIPU prepolymer | 0.5 |
| prepolymer 1 | | |
| 13003 diacrylate | Polyester | 0.2 |
| prepolymer | prepolymer | |
| Isobornyl acrylate | Reactive diluent | 0.3 |
| (IBOA) | monomer | |
| XPB772 | Plant-based | 2% |
| | carbon black | (by weight) |

In one embodiment, the mixing ratio of NIPU diacrylamide prepolymer 1 to 13003 diacrylate prepolymer to IBOA may be within the range of 0.2-0.7:0.1-0.4:0.2-0.7.

6.2.7. Formulation 7

| | | Mixing |
|---|---|---|
| | | amount |
| Tradename/Name | Element | ratio |
| NIPU diacrylamide | NIPU prepolymer | 0.5 |
| prepolymer 3 | | |
| 13003 diacrylate | Polyester | 0.2 |
| prepolymer | prepolymer | |
| Isobornyl acrylate | Reactive diluent | 0.15 |
| (IBOA) | monomer | |
| Lauryl acrylate | Reactive diluent | 0.15 |
| (LA) | monomer | |
| XPB772 | Plant-based | 2% |
| | carbon black | (by weight) |

In one embodiment, the mixing ratio of NIPU diacrylamide prepolymer 3 to 13003 diacrylate prepolymer to IBOA to LA may be within the range of 0.2-0.7:0.1-0.4:0.05-0.4:0.05-0.4.

### 7. EQUIVALENTS AND INCORPORATION BY REFERENCE

While the invention has been particularly shown and described with reference to a preferred embodiment and various alternate embodiments, it will be understood by persons skilled in the relevant art that various changes in form and details can be made therein without departing from the spirit and scope of the present disclosure.

All references, issued patents and patent applications cited within the body of the instant specification are hereby incorporated by reference in their entirety, for all purposes.

What is claimed is:

1. A biobased radiation curable formula for a flexible substrate coating, the formula comprising a combination of materials selected from:
(i) one or more biobased (meth)acrylamide/itaconate functional non-isocyanate polyurethane (NIPU) prepolymers;
(ii) one or more biobased (meth)acrylate functional polyesters/polyethers/polycarbonates/polyamides prepolymers; and
(iii) one or more biobased (meth)acrylate monomers as reactive diluents.

2. The formula of claim 1, wherein the one or more biobased (meth)acrylamide/itaconate functional NIPU prepolymers are formed by reacting one or more plant oils-based carbonates with an amount of biobased diamine monomers to produce amino functional NIPU prepolymers.

3. The formula of claim 2, wherein the amino functional NIPU prepolymers have a molecular weight ranging from 1000 to 10,000.

4. The formula of claim 2, wherein the one or more plant oils-based carbonates are synthesized by carbon dioxide insertion in epoxidized modified plant-based oils.

5. The formula of claim 4, wherein the synthesized plant oils-based carbonates are biobased and carbon negative.

6. The formula of claim 4, wherein the epoxidized modified plant-based oils comprise an oil with a degree of functionality of 2.

7. The formula of claim 4, wherein the epoxidized modified plant-based oils comprise epoxidized propylene glycol dioleate.

8. The formula of claim 2, wherein the biobased diamine monomers comprise diaminoisosorbide, isophoronediamine (Vestamin® eCO IPD), lysine, furanyl amines, 1,5-diaminopentane, hexamethylenediamine, or dimer fatty acid diamine (Croda Priamine® 1071).

9. The formula of claim 1, wherein one or more biobased (meth)acrylate functional polyesters/polyethers/polycarbonates/polyamides prepolymers are synthesized by modifying bio-based polyester polyols, bio-based polyether polyols, bio-based polycarbonate polyols or bio-based polyamide polyols through a one-step reaction with biobased acrylic acid or methacrylic acid.

10. The formula of claim 9, wherein the bio-based polyester polyols, bio-based polyether polyols, bio-based polycarbonate polyols and bio-based polyamide polyols comprise Bio-Hoopol products from Synthesia Technology Group (11003, 11904, 12003 and 13003), CA-D020SZX and CA-D020SuZX from Gantrade, Velvetol® from WeylChem; EMEROX® Polyols from Emery Oleochemicals: Reactive polyamide polyols (Aptalon™ 9500, Aptalon™ 9501, Aptalon™ XPD 8502 and Aptalon™ XPD 8511) from Lubrizol, BENEBIOL NL2000D from Mitsubishi Chemical, Bio polyols (B-5613, B-3235 and B-3784) from Mitsui Chemicals and SKC Polyurethanes Inc (MCNS), Sovermol® from BASF, BiOH® products from Cargill, and Priplast from Croda.

11. The formula of claim 1, wherein the biobased (meth)acrylate monomers as reactive diluents comprise one or a combination of biobased isobornyl acrylate (IBOA) and lauryl acrylate (LA).

12. A method for radiation-curing a coating for a flexible substrate, comprising:
applying one or more layers of fluids on a release paper, each layer including a radiation-curable formula for a coating;
radiation-curing the one or more layers of fluids; and
applying a flexible substrate backing on the one or more layers.

13. The method of claim 12, wherein each layer of fluid includes a formula comprising:
(i) one or more biobased (meth)acrylamide/itaconate functional non-isocyanate polyurethane (NIPU) prepolymers;
(ii) one or more biobased (meth)acrylate functional polyesters/polyethers/polycarbonates/polyamides prepolymers; and
(iii) one or more biobased (meth)acrylate monomers as reactive diluents.

14. The method of claim 12, wherein applying the one or more layers of fluids comprises:
applying a top surface layer on the release paper;
applying a bulk body layer on the top surface layer; and
radiation-curing the one or more layers of fluids comprises simultaneously radiation-curing the top surface layer and the bulk body layer.

15. The method of claim 14, further comprising applying the top surface layer and the bulk body layer simultaneously or near simultaneously through a pre-metered slot die coating method.

16. The method of claim 12, further comprising:
applying an adhesive layer on the one or more layers of fluids; and
radiation-curing the adhesive layer.

17. The method of claim 16, wherein the adhesive layer comprises a black pigmented NIPU (meth)acrylamide/itaconate formula with a thermally activated initiator.

18. The method of claim 16, wherein the adhesive layer comprises an amine-terminated NIPU prepolymer with acrylated soybean oil without a thermal initiator.

19. The method of claim 12, wherein the flexible substrate is one of leather, faux leather, fabric, cloth, flexible polyurethane (PU) fabric, or a backing textile.

20. A coated flexible substrate construct formed by the method of claim 12.

21. A radiation-cured coating for a flexible substrate, the coating comprising polymerized material of a combination of materials selected from:
(i) one or more biobased (meth)acrylamide/itaconate functional non-isocyanate polyurethane (NIPU) prepolymers;
(ii) one or more biobased (meth)acrylate functional polyesters/polyethers/polycarbonates/polyamides prepolymers; and
(iii) one or more biobased (meth)acrylate monomers as reactive diluents.

22. The coating of claim 21, wherein the one or more biobased (meth)acrylamide/itaconate functional NIPU prepolymers are formed by reacting one or more plant oils-based carbonates with an amount of biobased diamine monomers to produce amino functional NIPU prepolymers.

23. The coating of claim 22, wherein the amino functional NIPU prepolymers have a molecular weight ranging from 1000 to 10,000.

24. The coating of claim 22, wherein the one or more plant oils-based carbonates are synthesized by carbon dioxide insertion in epoxidized modified plant-based oils.

25. The coating of claim 24, wherein the synthesized plant oils-based carbonates are biobased and carbon negative.

26. The coating of claim 24, wherein the epoxidized modified plant-based oils comprise an oil with a degree of functionality of 2.

27. The coating of claim 24, wherein the epoxidized modified plant-based oils comprise epoxidized propylene glycol dioleate.

28. The coating of claim 22, wherein the biobased diamine monomers comprise diaminoisosorbide, isophoronediamine (Vestamin® eCO IPD), lysine, furanyl amines, 1,5-diaminopentane, hexamethylenediamine, or dimer fatty acid diamine (Croda Priamine® 1071).

29. The coating of claim 21, wherein one or more biobased (meth)acrylate functional polyesters/polyethers/polycarbonates/polyamides prepolymers are synthesized by modifying bio-based polyester polyols, bio-based polyether polyols, bio-based polycarbonate polyols or bio-based polyamide polyols through a one-step reaction with biobased acrylic acid or methacrylic acid.

30. The coating of claim 29, wherein the bio-based polyester polyols, bio-based polyether polyols, bio-based polycarbonate polyols and bio-based polyamide polyols comprise Bio-Hoopol products from Synthesia Technology Group (11003, 11904, 12003 and 13003), CA-D020SZX and CA-D020SuZX from Gantrade, Velvetol® from WeylChem: EMEROX® Polyols from Emery Oleochemicals: Reactive polyamide polyols (Aptalon™ 9500, Aptalon™ 9501, Aptalon™ XPD 8502 and Aptalon™ XPD 8511) from Lubrizol, BENEBIOL NL2000D from Mitsubishi Chemical, Bio polyols (B-5613, B-3235 and B-3784) from Mitsui Chemicals and SKC Polyurethanes Inc (MCNS), Sovermol® from BASF, BiOH® products from Cargill, and Priplast from Croda.

31. The coating of claim 21, wherein the biobased (meth)acrylate monomers as reactive diluents comprise one or a combination of biobased isobornyl acrylate (IBOA) and lauryl acrylate (LA).
